(19) United States
(12) Patent Application Publication
(10) Pub. No.: US 2023/0223687 A1
(43) Pub. Date: Jul. 13, 2023

(54) PHASE SHIFTERS FOR ANTENNA TILT

(71) Applicant: SKYWORKS SOLUTIONS, INC., Irvine, CA (US)

(72) Inventors: Grant Darcy POULIN, Carp (CA); William J. DOMINO, Yorba Linda, CA (US); Patrick Marcus NARAINE, Irvine, CA (US); Steven Russell PENNEY, Ottawa (CA)

(21) Appl. No.: 18/092,176

(22) Filed: Dec. 30, 2022

Related U.S. Application Data
(60) Provisional application No. 63/295,527, filed on Dec. 31, 2021.

(51) Int. Cl. H01Q 3/36; H01Q 1/24

(52) U.S. Cl. CPC H01Q 3/36; H01Q 1/246

(57) ABSTRACT

An antenna architecture can include a common node and a plurality of signal paths each having first and second ends, with the first end coupled to the common node, such that a common signal provided at the common node splits into respective signals in the signal paths. The antenna architecture can further include a phase shifter block implemented along each of at least some of the signal paths, with the phase shifter block including a phase shifting line to provide a phase shift for the signal passing through the respective signal path, such that the signals emerging from the signal paths are provided with incremental phase shifts. The antenna architecture can further include an antenna unit coupled to the second end of each signal path, such that the signals provided to the antenna units result in a transmitted signal being directed at a tilt angle with respect to the antenna units.

### CROSS-REFERENCE TO RELATED APPLICATION(S)

This application claims priority to U.S. Provisional Application No. 63/295,527 filed Dec. 31, 2021, entitled PHASE SHIFTERS FOR ANTENNA TILT, the disclosure of which is hereby expressly incorporated by reference herein in its respective entirety.

### BACKGROUND

### Field

The present disclosure relates to circuits, devices, systems and methods for providing phase shifting for antenna tilt in radio-frequency (RF) applications.

### Description of the Related Art

In radio-frequency (RF) applications, beam steering can be achieved by mechanical tilting of an antenna tilt. Beam steering can also be achieved by a non-mechanical technique where an antenna maintains a fixed orientation, and beam steering is provided by an electrical control of a plurality of antenna-elements.

### SUMMARY

In accordance with some implementations, the present disclosure relates to an antenna architecture that includes a common node and a plurality of signal paths each having first and second ends, with the first end coupled to the common node, such that a common signal provided at the common node splits into respective signals in the signal paths. The antenna architecture further includes a phase shifter block implemented along each of at least some of the signal paths, with the phase shifter block including a phase shifting line configured to provide a phase shift for the signal passing through the respective signal path, such that the signals emerging from the signal paths are provided with incremental phase shifts. The antenna architecture further includes an antenna unit coupled to the second end of each signal path, such that the signals provided to the antenna units result in a transmitted signal being directed at a tilt angle with respect to the antenna units.

In some embodiments, the common node can be configured to be coupled to a transceiver through a power amplifier. In some embodiments, the antenna unit can include an antenna pair.

In some embodiments, each incremental phase shift can have a value of Δφ. The plurality of signal paths can include N signal paths, with the quantity N being an integer greater than 1.

In some embodiments, the quantity N can be an even number. The signal paths can include a first signal path providing a phase shift of zero for a first antenna unit, and a second signal path providing a phase shift of −Δφ with a respective phase shifter block for a second antenna unit on one side of the first antenna unit. The signal paths can further include a third signal path providing a phase shift of +Δφ with a respective phase shifter block for a third antenna unit on the other side of the first antenna unit, and a fourth signal path providing a phase shift of −2Δφ with a respective phase shifter block for a fourth antenna unit next to the second antenna unit.

In some embodiments, the quantity N cam be an odd number. The signal paths can include a first signal path providing a phase shift of zero for a first antenna unit, a second signal path providing a phase shift of −Δφ with a respective phase shifter block for a second antenna unit on one side of the first antenna unit, and a third signal path providing a phase shift of +Δφ with a respective phase shifter block for a third antenna unit on the other side of the first antenna unit. The signal paths can further include a fourth signal path providing a phase shift of −2Δφ with a respective phase shifter block for a fourth antenna unit next to the second antenna unit, and a fifth signal path providing a phase shift of +2Δφ with a respective phase shifter block for a fifth antenna unit next to the third antenna unit.

In some embodiments, N-1 of the signal paths can be provided with a respective phase shifter block, and the remaining one signal path not include a phase shifter block. The phase shifting line of each of the N-1 phase shifter blocks for supporting the tilt angle of the transmitted signal can be one of M phase shifting lines corresponding to M tilt angles of the transmitted signal, with the quantity M being an integer greater than 1, such that the phase shifter block is configured to switchably introduce a selected phase shifting line for the phase shifter block to support a selected tilt angle of the transmitted signal.

In some embodiments, each phase shifter block can include a first SPMT switch with the single pole coupled to the common node and the M throws coupled to first ends of the M phase shifting lines, and a second SPMT switch with the M throws coupled to second ends of the M phase shifting lines and the single pole coupled to the respective antenna unit.

In some embodiments, the N-1 phase shifter blocks can include a phase shifter block for providing a phase shift of +Δφ and another phase shifter block for providing a phase shift of −Δφ. In some embodiments, each of the M switchable phase shifting lines of the phase shifter block can be dimensioned to provide the phase shift of +Δφ in a positive direction from zero degree, and each of the M switchable phase shifting lines of the other phase shifter block can be dimensioned to provide the phase shift of −Δφ in a negative direction from zero degree. In some embodiments, each of the M switchable phase shifting lines of the phase shifter block can be dimensioned to provide the phase shift of +Δφ in a positive direction from zero degree, and the other phase shifter block can include M switchable phase shifting lines that are dimensioned the same as the M switchable phase shifting lines of the phase shifter block. The other phase shifter block can further include a static phase shifting line in line with the M switchable phase shifting lines, such that the other phase shifter block provides the phase shift of −Δφ.

In some embodiments, at least the phase shifting line can be implemented on a substrate having a dielectric constant greater than 20, 30, or 40. The substrate can have a dielectric constant of, for example, approximately 50. The substrate can include, for example, a ceramic substrate.

In some embodiments, the architecture can be configured to be capable of supporting cellular functionality. In some embodiments, the cellular functionality can include 5G cellular functionality.

In some implementations, the present disclosure relates to a method for operating a plurality of antenna units. The method includes providing a common signal to a common node and splitting the common signal into a plurality of signal paths each having first and second ends, with the first end coupled to the common node, such that the common signal splits into respective signals in the signal paths. The method further includes providing a phase shift along each of at least some of the signal paths, with the phase shift being provided at least in part by a phase shifting line along the respective signal path, such that the signals emerging from the signal paths are provided with incremental phase shifts. The method further includes transmitting a signal through an antenna unit coupled to the second end of each signal path, such that the transmitted signal from the antenna units is directed at a tilt angle with respect to the antenna units.

In some implementations, the present disclosure relates to a wireless system that includes a transceiver and an antenna architecture operatively coupled to the transceiver. The antenna architecture includes a common node and a plurality of signal paths each having first and second ends, with the first end coupled to the common node, such that a common signal provided at the common node splits into respective signals in the signal paths. The antenna architecture further includes a phase shifter block implemented along each of at least some of the signal paths, with the phase shifter block including a phase shifting line configured to provide a phase shift for the signal passing through the respective signal path, such that the signals emerging from the signal paths are provided with incremental phase shifts. The antenna architecture further includes an antenna unit coupled to the second end of each signal path, such that the signals provided to the antenna units result in a transmitted signal being directed at a tilt angle with respect to the antenna units.

In some embodiments, the wireless system can be part of a base station. In some embodiments, the base station can be configured to provide cellular functionality. In some embodiments, the cellular functionality can include 5G functionality.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 depicts an example of how an electrical beam tilt can be provided.

FIG. 2 depicts an example antenna architecture that can provide massive MIMO (mMIMO) functionality without separate phase shifters.

FIG. 3 depicts an antenna architecture that can include one or more features as described herein.

FIG. 4 shows examples of antenna architectures utilizing different numbers of antenna pairs.

FIG. 5 shows examples of phase shifter blocks that can be implemented for the antenna architecture of FIG. 4.

FIG. 6 shows a line representation of the phase shifter blocks, as in the example of FIG. 5.

FIG. 7 shows an example of phase shifter blocks that can be implemented as an alternative embodiment to the example of FIG. 5.

FIG. 8 depicts a size comparison between a first assembly of four modules that have high dielectric constant ceramic as a substrate, and a second assembly of four functionally similar modules that have FR4 as a substrate.

FIG. 9 shows examples of switching linearity performance of switches that can be utilized in an antenna architecture as described herein.

FIG. 10 depicts a wireless system having an antenna architecture that includes one or more features as described herein.

FIG. 11 shows that in some embodiments, the wireless system of FIG. 10 can be implemented in a base station.

FIG. 12 shows that in some embodiments, the wireless system of FIG. 10 can be implemented in a mobile device.

### DETAILED DESCRIPTION OF SOME EMBODIMENTS

The headings provided herein, if any, are for convenience only and do not necessarily affect the scope or meaning of the claimed invention.

In radio-frequency (RF) applications, such as in 5G macro basestations, mechanical antenna tilt is utilized to provide coarse beam steering. For example, an antenna may have a 5 to 15 degree downtilt applied so that the beam covers a target area on the ground.

Described herein are examples related to architectures, circuits, devices and methods related to electrical tilting of antennas. While such examples are described in the example context of 5G basestations, it will be understood that one or more features of the present disclosure can also be utilized in other RF frequency ranges and/or other settings.

Electrical beam tilt can be implemented by applying a linear phase shift across a number of antennas. In many RF applications, such phase shifters typically need to handle high powers, as they are placed between power amplification and the antennas. Size and insertion loss associated with the phase shifters is also an important design consideration.

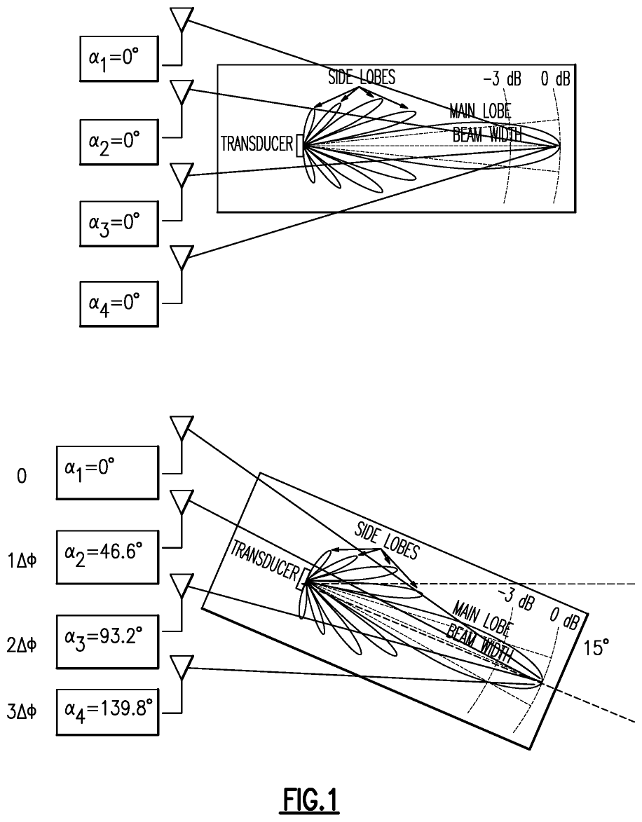

FIG. 1 depicts an example of how an electrical beam tilt (e.g., a downtilt) can be provided. In the example of FIG. 1, four antennas are shown to be provided. If the four antennas are provided with the same signal through respective signal paths, with each signal path providing a respective phase shift α, a beam resulting from the four antennas can be steered. More particularly, if the neighboring antennas are separated in space by dₓ (in terms of wavelength λ), and a beam tilt of θ degrees is desired, an incremental phase α applied to each antenna can be α°=360*dₓ*sin θ.

As shown in the upper portion of FIG. 1, if all four antennas are driven in phase, α=0, and there is no tilt (sin θ=0).

As shown in the lower portion of FIG. 1, and assuming that antenna spacing dₓ=0.5λ, if a 15° downtilt degrees (θ=15°) is desired, α=360*0.5*sin(15°)=−46.6°. Accordingly, the first antenna (e.g., the uppermost antenna in FIG. 1) can be provided with a phase shift of α₁=0°, the second antenna can be provided with a phase shift of α₂=α₁+46.6°=46.6°, the third antenna can be provided with a phase shift of α₃=α₂+46.6°=93.2°, and the fourth antenna can be provided with a phase shift of α₄=α₃+46.6°=139.8°.

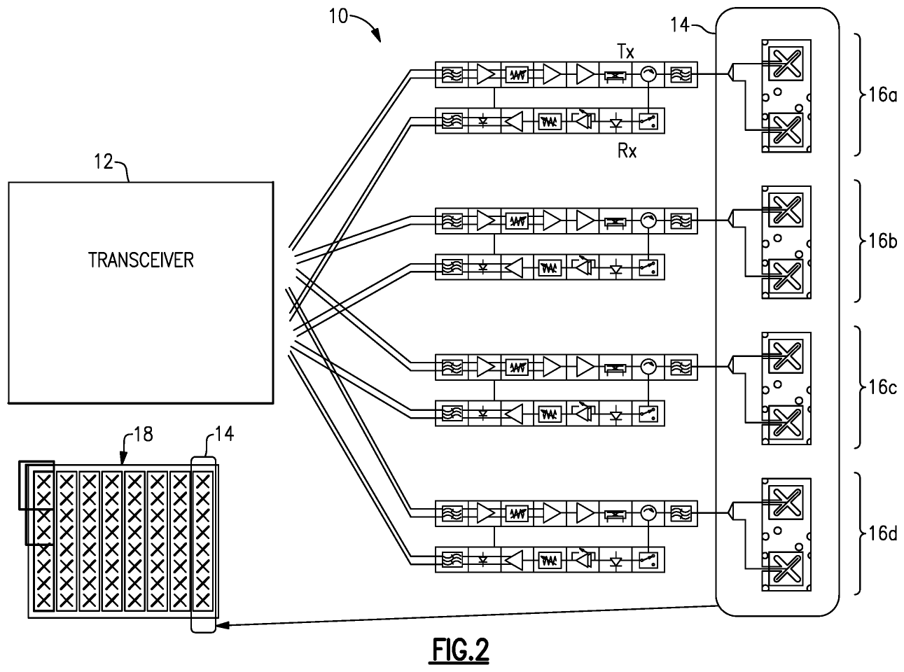

FIG. 2 depicts an example antenna architecture 10 that can provide massive multiple-input and multiple-output (mMIMO) functionality without separate phase shifters. In such an architecture, a column 14 of antenna pairs (e.g., 16a, 16b, 16c, 16d) is shown to be coupled to a transceiver 12, such that each two-antenna pair is provided with an ADC/DAC and transmit/receive (TRx) chain. In the example of FIG. 2, the column 14 of antenna pairs is shown to be a part of an antenna array 18.

In the example of FIG. 2, the architecture 10 is shown to include Txvr+4FEMS+4 filters+4 splitters for each polarization and for each antenna column 14. Such a system can implement any of 64TR/32TR/16TR functionalities.

In the example of FIG. 2, phasing is applied in digital domain, so external phase shifters not present. Such a system of FIG. 2 can provide a high degree of flexibility, but typically at a high cost.

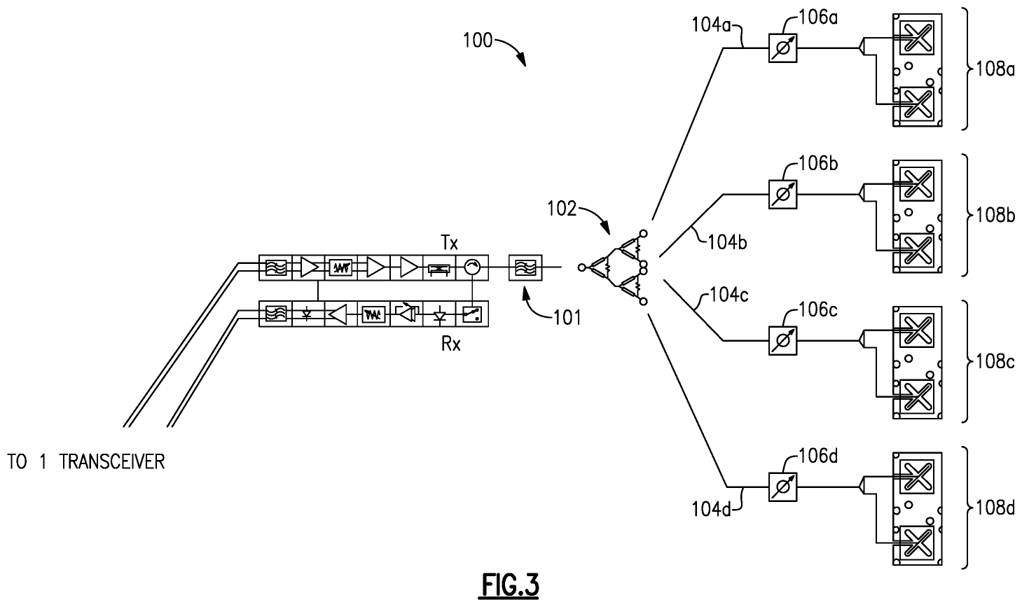

FIG. 3 depicts an antenna architecture 100 that can include one or more features as described herein. In such an architecture, instead of driving each pair of antennas with a set of DAC+transceiver chain+filter, a signal from a single transceiver+front-end module (FEM)+filter stage can be split into N paths corresponding to the number of pairs of antennas. Thus, in the example of FIG. 3, a splitter 102 is shown to provide the signal from the transceiver into four paths 104a, 104b, 104c, 104d corresponding to antenna pairs 108a, 108b, 108c, 108d that include eight antennas.

In some embodiments, such an architecture of FIG. 3 can include phase shifters for each antenna pair. Thus, for the example of FIG. 3, phase shifters 106a can be provided along the path 104a for the antenna pair 108a, phase shifters 106b can be provided along the path 104b for the antenna pair 108b, phase shifters 106c can be provided along the path 104c for the antenna pair 108c, and phase shifters 106d can be provided along the path 104d for the antenna pair 108d.

It is noted that in the example of FIG. 3, phase shifting for the antenna architecture 100 is not implemented at baseband, since the signal is split just prior to the antennas.

It is also noted that the example antenna architecture 100 of FIG. 3 can be desirable for a number of reasons. For example, the antenna architecture 100 of FIG. 3 can be implemented with a lower cost when compared to the antenna architecture 10 of FIG. 2, since the architecture 100 of FIG. 3 utilizes four times fewer baseband paths, transceivers, and filters. In another example, increased range can be achieved in the architecture 100 of FIG. 3, due to the four antenna pairs providing, for example, 6 dBi, and such an increased range can be desirable in settings such as rural applications.

In the example of FIG. 3, since beam tilting is not implemented at baseband, external phase shifters can be provided near the antenna pairs. Examples of such phase shifters are described herein in greater detail.

In the example of FIG. 3, throughput can be less than that of the example of FIG. 2. Further, possible reduction in range resulting from post-power amplifier losses due to the splitter and the phase shifter can be considered for the example of FIG. 3.

In the example of FIG. 3, a filter 101 is shown to be implemented before the splitter 102 and thus the phase shifters 106 (when viewed in a transmit operation). Accordingly, in some embodiments, a high linearity switches (e.g., IIP3=+85 dBm) can be utilized after such a filter. Examples of such switches implemented with the phase shifters are described herein in greater detail.

In the example of FIG. 3, a larger power amplifier can be implemented. Each power amplifier serves four antenna pairs in the example antenna architecture 100; thus, the power amplifier can be configured to deliver, for example, −7 dB more Tx power to account for losses associated with the splitter and the four phase shifters.

In the example architecture of FIG. 3, four antenna pairs are shown. As described herein, different numbers of antenna pairs can be implemented utilizing one or more features of the present disclosure.

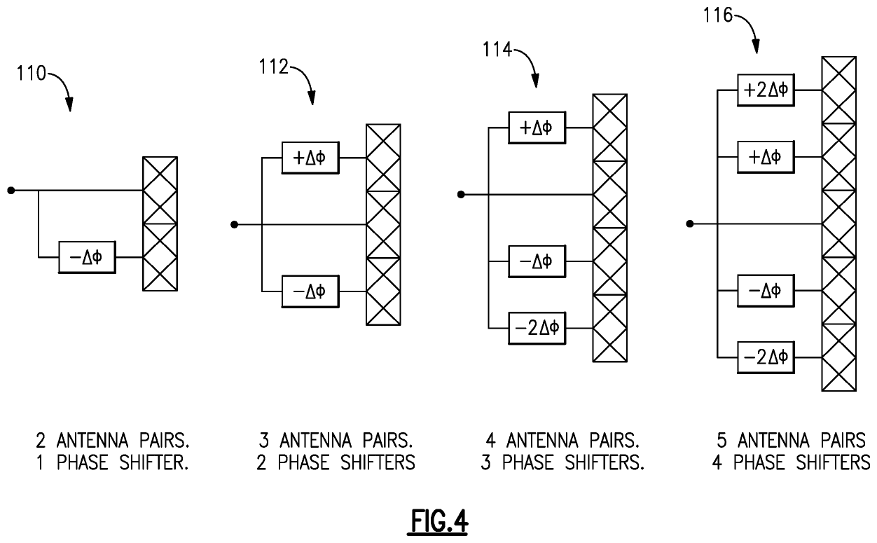

FIG. 4 shows examples of antenna architectures utilizing different numbers of antenna pairs. For example, an antenna architecture 110 is shown to include two antenna pairs coupled to a common node through respective paths, with each path providing a respective phase shift. For such a configuration having two antenna pairs, a phase shifter can be provided along one of the two paths, with the other path providing no phase shift or a desired phase shift by the path itself. Accordingly, one phase shifter is implemented for the antenna architecture 110.

In another example, an antenna architecture 112 is shown to include three antenna pairs coupled to a common node through respective paths, with each path providing a respective phase shift. For such a configuration having three antenna pairs, a phase shifter can be provided along each of two of the three paths, with the remaining path providing no phase shift or a desired phase shift by the path itself. Accordingly, two phase shifters are implemented for the antenna architecture 112.

In yet another example, an antenna architecture 114 is shown to include four antenna pairs coupled to a common node through respective paths, with each path providing a respective phase shift. For such a configuration having four antenna pairs, a phase shifter can be provided along each of three of the four paths, with the remaining path providing no phase shift or a desired phase shift by the path itself. Accordingly, three phase shifters are implemented for the antenna architecture 114.

In yet another example, an antenna architecture 116 is shown to include five antenna pairs coupled to a common node through respective paths, with each path providing a respective phase shift. For such a configuration having five antenna pairs, a phase shifter can be provided along each of four of the five paths, with the remaining path providing no phase shift or a desired phase shift by the path itself. Accordingly, four phase shifters are implemented for the antenna architecture 116.

By way of examples, and referring to FIG. 4, assume that phase shifts of 4, 8, and 12 degrees are desired. Phase shifter blocks can be configured to provide beam steering utilizing the 2, 3, 4, or 5 antenna pair architectures. Examples of such phase shifter blocks are described herein in greater detail.

In some embodiments, phase shifts of ±1φ and ±2φ may be sufficient for desired beam tilts for up to five antenna pairs. However, it will be understood that one or more features of the present disclosure can also be implemented to provide beam tilts utilizing greater numbers of antenna pairs.

In the context of an antenna architecture having five antenna pairs with four phase shifter blocks (as depicted in FIG. 4), examples of such four phase shifter blocks are described herein.

It is noted that in some embodiments, electrical downtilt is independent of frequency if transmit (Tx) line phase shifters are utilized. Electrical length of a Tx line may change, but the desired phase shift can change accordingly.

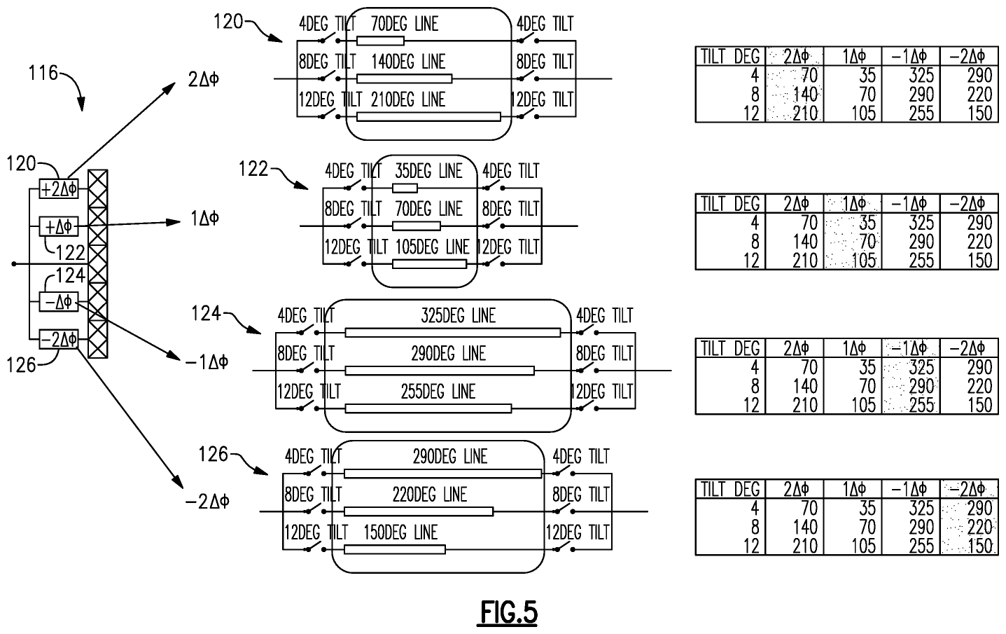

FIG. 5 shows examples of phase shifter blocks that can be implemented for the antenna architecture 116 of FIG. 4. In FIG. 5, four phase shifter blocks 120, 122, 124, 126 are shown to be provided along four paths coupled to their respective antenna pairs, with the middle path being without a phase shifter block. More particularly, the first phase shifter block 120 is shown to be implemented along the first path coupled to the upper-most antenna pair (when viewed as shown in FIG. 5), and configured to be capable of providing a phase shift of +2Δφ for each of 4, 8 and 12 degrees of tilts (e.g., downtilts). In some embodiments, such a phase shift for the three example tilt angles can be provided by the first phase shifter block 120 having a 70 degree line, a 140 degree line, and a 210 degree line, with switches being provided at both ends of each line. Thus, a 4 degree tilt switch is shown to be provided at each end of the 70 degree line; a 8 degree tilt switch is shown to be provided at each end of the 140 degree line; and a 12 degree tilt switch is shown to be provided at each end of the 210 degree line.

Referring to FIG. 5, the second phase shifter block 122 is shown to be implemented along the second path coupled to the antenna pair second from the top (when viewed as shown in FIG. 5), and configured to be capable of providing a phase shift of +1Δφ for each of 4, 8 and 12 degrees of tilts (e.g., downtilts). In some embodiments, such a phase shift for the three example tilt angles can be provided by the second phase shifter block 122 having a 35 degree line, a 70 degree line, and a 105 degree line, with switches being provided at both ends of each line. Thus, a 4 degree tilt switch is shown to be provided at each end of the 35 degree line; a 8 degree tilt switch is shown to be provided at each end of the 70 degree line; and a 12 degree tilt switch is shown to be provided at each end of the 105 degree line.

Referring to FIG. 5, the third path from the common node to the third antenna pair (middle pair when viewed as shown in FIG. 5) is shown to be without a phase shifter block. For the purpose of description, it will be assumed that a phase shift of zero is being provided along the third path.

Referring to FIG. 5, the third phase shifter block 124 is shown to be implemented along the fourth path coupled to the antenna pair second from the bottom (when viewed as shown in FIG. 5), and configured to be capable of providing a phase shift of −1Δφ for each of 4, 8 and 12 degrees of tilts (e.g., downtilts). In some embodiments, such a phase shift for the three example tilt angles can be provided by the third phase shifter block 124 having a 325 degree line, a 290 degree line, and a 255 degree line, with switches being provided at both ends of each line. Thus, a 4 degree tilt switch is shown to be provided at each end of the 325 degree line; a 8 degree tilt switch is shown to be provided at each end of the 290 degree line; and a 12 degree tilt switch is shown to be provided at each end of the 255 degree line.

Referring to FIG. 5, the fourth phase shifter block 126 is shown to be implemented along the fifth path coupled to the lower-most antenna pair (when viewed as shown in FIG. 5), and configured to be capable of providing a phase shift of −2Δφ for each of 4, 8 and 12 degrees of tilts (e.g., downtilts). In some embodiments, such a phase shift for the three example tilt angles can be provided by the fourth phase shifter block 126 having a 290 degree line, a 220 degree line, and a 150 degree line, with switches being provided at both ends of each line. Thus, a 4 degree tilt switch is shown to be provided at each end of the 290 degree line; a 8 degree tilt switch is shown to be provided at each end of the 220 degree line; and a 12 degree tilt switch is shown to be provided at each end of the 150 degree line.

Configured in the foregoing manner, a desired tilt angle can be provided by closing appropriate switches and opening the remaining switches based on selected lines of the four phase shifter blocks. For example, and as shown in the tables on the right side of FIG. 5, a 4 degree tilt angle can be achieved by closing the switches associated with the 70 degree line and opening the remaining switches of the first phase shifter block (+2Δφ); closing the switches associated with the 35 degree line and opening the remaining switches of the second phase shifter block (+1Δφ); closing the switches associated with the 325 degree line and opening the remaining switches of the third phase shifter block (−1Δφ); and closing the switches associated with the 290 degree line and opening the remaining switches of the fourth phase shifter block (−2Δφ).

Similarly, a 8 degree tilt angle can be achieved by closing the switches associated with the 140 degree line and opening the remaining switches of the first phase shifter block (+2Δφ); closing the switches associated with the 70 degree line and opening the remaining switches of the second phase shifter block (+1Δφ); closing the switches associated with the 290 degree line and opening the remaining switches of the third phase shifter block (−1Δφ); and closing the switches associated with the 220 degree line and opening the remaining switches of the fourth phase shifter block (−2Δφ).

Similarly, a 12 degree tilt angle can be achieved by closing the switches associated with the 210 degree line and opening the remaining switches of the first phase shifter block (+2Δφ); closing the switches associated with the 105 degree line and opening the remaining switches of the second phase shifter block (+1Δφ); closing the switches associated with the 255 degree line and opening the remaining switches of the third phase shifter block (−1Δφ); and closing the switches associated with the 150 degree line and opening the remaining switches of the fourth phase shifter block (−2Δφ).

In FIG. 5, three example tilt angles are shown to be implemented. It will be understood that tilt angles can be different than the ones shown in FIG. 5. It will also be understood that if additional tilts are required or desired, each phase shifter block can provide additional phase shift(s) by, for example, adding line(s) associated with corresponding phase shift(s).

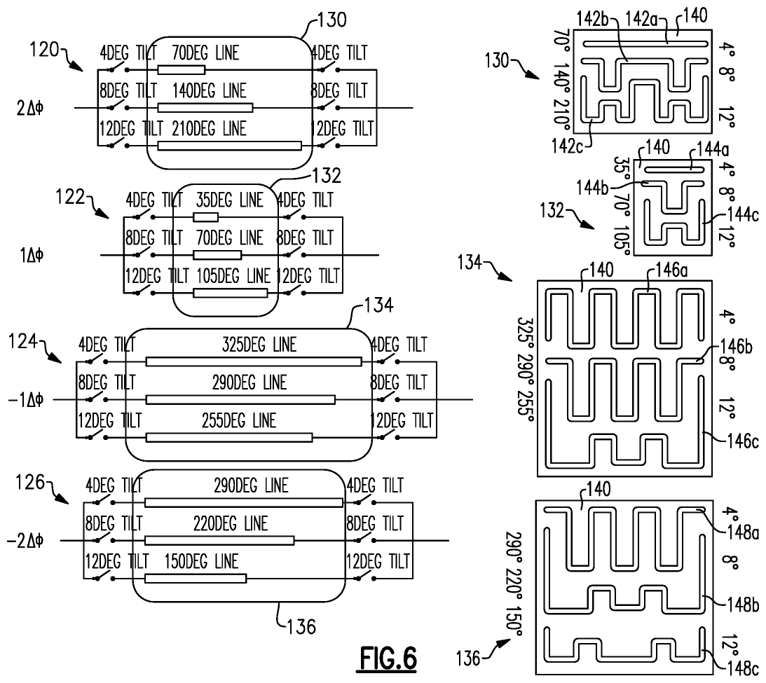

FIG. 6 shows a line representation of the phase shifter blocks 120, 122, 124, 126, as in the example of FIG. 5. FIG. 6 also shows examples of metal traces that can be implemented to provide the phase shifting lines of the phase blocks 120, 122, 124, 126. More particularly, a first module 130 can include a substrate 140 and metal traces 142a, 142b, 142c for providing 70, 140, 210 degree line properties to support 4, 8, 12 degree tilt functionalities. Similarly, a second module 132 can include a substrate 140 and metal traces 144a, 144b, 144c for providing 35, 70, 105 degree line properties to support the 4, 8, 12 degree tilt functionalities. Similarly, a third module 134 can include a substrate 140 and metal traces 146a, 146b, 146c for providing 325, 290, 255 degree line properties to support the 4, 8, 12 degree tilt functionalities. Similarly, a fourth module 136 can include a substrate 140 and metal traces 148a, 148b, 148c for providing 290, 220, 150 degree line properties to support the 4, 8, 12 degree tilt functionalities.

In some embodiments, each substrate (140) of the modules 130, 132, 134, 136 can include a material with high dielectric constant. For example, a high dielectric constant (e.g., about 50) ceramic can be utilized as the substrate 140 of the modules 130, 132, 134, 126. Use of such a high dielectric constant material can significantly reduce sizes of the modules, and also significantly reduce losses of the phase shifting lines, when compared to, for example, an FR4 substrate.

In some embodiments, a given module (e.g., 130, 132, 134 or 136) can include the substrate 140 (e.g., ceramic substrate) and the switches associated with the phase shifting lines. For example, for the three-tilt angle configuration of FIG. 6, a first SP3T switch can be implemented, with its single pole being coupled to the common node and its three throws being coupled to the three phase shifting lines. A second SP3T switch can also be implemented, with its three throws being coupled to the three phase shifting lines and its single pole being coupled to the respective antenna pair.

It is noted that if a module is configured to provide different numbers of tilt angles, switches associated with the phase shifting lines can be configured accordingly. For example, SP4T switches can be utilized for four-tilt angles, and SP6T switches can be utilized for six-tilt angles.

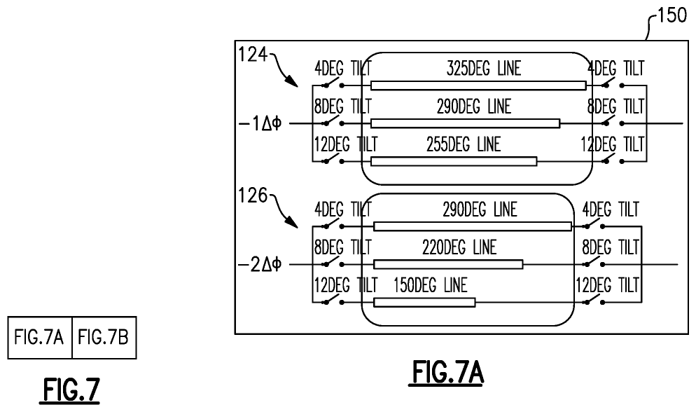

FIG. 7 shows an example of phase shifter blocks that can be implemented as an alternative embodiment to the example of FIG. 5. In the example of FIG. 7, phase shifter blocks 120, 122 are the same as the phase shifter blocks 120, 122 of FIG. 5. In FIG. 7, phase shifter blocks 124, 126 (collectively indicated as 150) are replaced with an assembly 150′ that includes phase shifter blocks 122′, 120 that have the same structures as the phase shifter blocks 122, 120.

More particularly, the phase shifter block 122′ can be configured to be capable of providing a phase shift of −1Δφ for each of 4, 8 and 12 degrees of tilts by utilizing phase shifting lines similar to those of the phase shifter block 122. For example, the foregoing −1Δφ phase shift for the three example tilt angles can be provided by a static phase shifting line 123′ (220 degree line) in line with a switchable assembly of a 105 degree line, a 70 degree line, and a 35 degree line. It is noted that such a switchable assembly of three lines has the same structure as the three lines of the phase shifting block 122.

Similarly, the −2Δφ phase shift for the three example tilt angles can be provided by a static phase shifting line 121′ (80 degree line) in line with a switchable assembly of a 210 degree line, a 140 degree line, and a 70 degree line. It is noted that such a switchable assembly of three lines has the same structure as the three lines of the phase shifting block 120.

It is noted that in some implementations, the configuration of FIG. 7 can be desirable. For example, in FIG. 7, only two types of phase shifting modules (i.e., modules corresponding to the blocks 120, 122) are utilized instead of four types of modules in FIG. 5. Referring to the examples of such four modules in FIG. 6, it is further noted that the modules 130, 132 (corresponding to the blocks 120, 122) are generally smaller than the modules 134, 136 (corresponding to the replaced blocks 124, 126); and such smaller modules can be desirable in some applications.

In the example of FIG. 7, and referring to the −1Δφ phase shift (phase shifter block 122′), it is noted that to provide a 4 degree tilt, the 105 degree line is switched in, whereas in the phase shifter block 122, the 105 degree line is utilized to provide a 12 degree tilt. Similarly, to provide a 12 degree tilt with the phase shifter block 122′, the 35 degree line is switched in, whereas in the phase shifter block 122, the 35 degree line is utilized to provide a 4 degree tilt. Such differences in uses of the phase shifting lines can be accommodated with logic changes for switches to swap the 4 degree and 12 degree lines to provide the −1Δφ and −2Δφ phase shifts.

As described herein, modules with phase shifter blocks can be based on a substrate such as FR4 or ceramic material. As also described herein, use of a high dielectric constant ceramic material can provide reduced module sizes as well as related benefits.

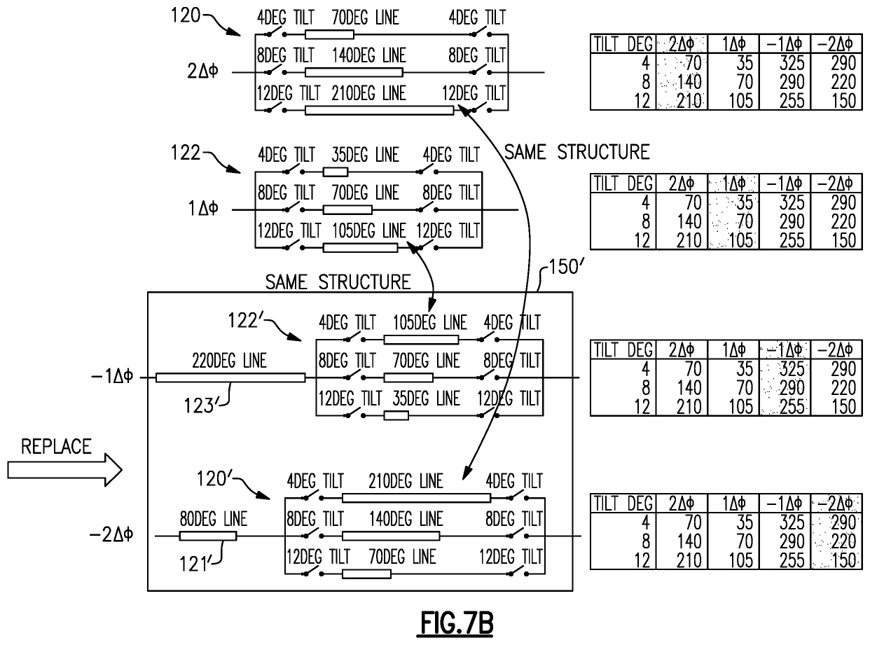

For example, FIG. 8 depicts a size comparison between a first assembly of four modules 130, 132, 134, 136 that have high dielectric constant ceramic 160 as a substrate 140, and a second assembly of four functionally similar modules 130′, 132′, 134′, 136′ that have FR4 162 as a substrate 140. The first assembly is shown to have a lateral footprint of about d1×d2, and the second assembly is shown to have a lateral footprint of about d3×d4.

In the foregoing size comparison, each lateral dimension of the first assembly (high dielectric constant ceramic substrate) is about 3.5 times less than the respective lateral dimension of the second assembly (FR4 substrate), and the area of the first assembly is about 12.25 times less than the area of the second assembly.

It is also noted that shorter physical length of the phase shifting lines and lower dielectric losses result in lower losses in the modules of the first assembly (high dielectric constant ceramic substrate). For example, in the first assembly (ceramic substrate with dielectric constant of 50), the longest phase shifting line corresponds to the 325 degree line; and such a line is shown to provide a loss of about 0.14 dB. In the second assembly (FR4 substrate with dielectric constant of 4), the longest phase shifting line also corresponds to the 325 degree line; and such a line is shown to provide a loss of 0.76 dB. Simulations show that overall, losses are lower in the modules of the first assembly by about 0.6 dB when compared to the modules of the second assembly (FR4 substrate).

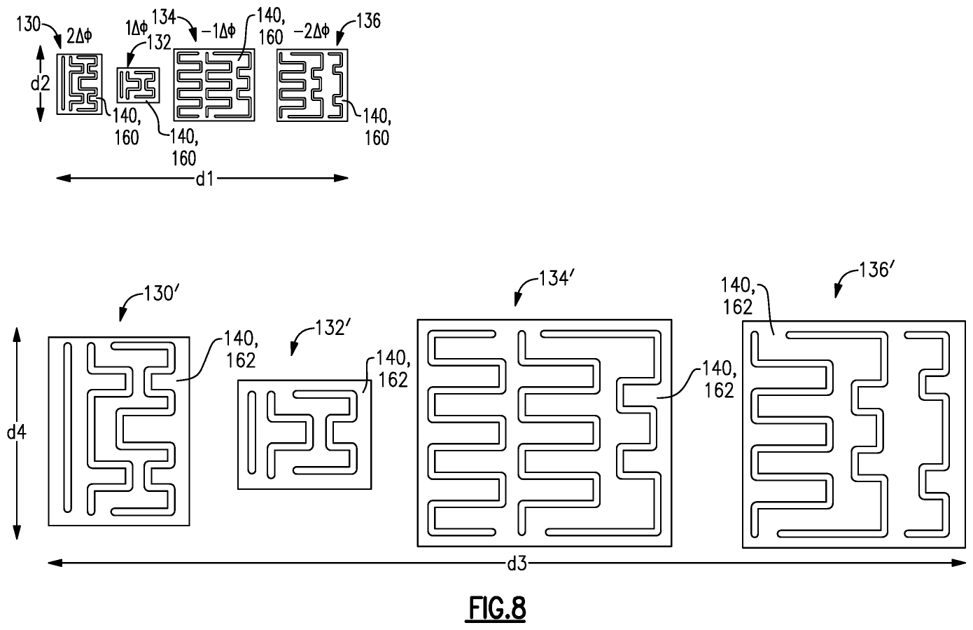

FIG. 9 shows examples of switching linearity performance of switches that can be utilized in an antenna architecture as described herein. For example, switches in FIGS. 5 and 7 can be utilized to select a phase shifting line for the phase shifter blocks. Simulations were carried out to look at the impact of having two series switches along a transmit line on spurious emissions due to 3rd order intermodulation.

Referring to FIG. 9, assume two 20 MHz wide orthogonal frequency division multiplexing (OFDM) signals are provided at 3.3 and 4.2 GHz, each at 40 dBm. Switch IIP3 of 85 dBm is assumed. IM3 spurious signals appear at 2400 and 5100 MHz. IIP3 of +85 dBm results in spurious emissions at −53.7 dBm/MHz, providing a 1.7 dB margin to a spurious specification (e.g., 3GPP specification in TS38.104 defines maximum allowed spurious emissions in many different bands, including, for example, emissions in band 46 (5150-5925 MHz) are to have a maximum of −52 dBm/MHz). Accordingly, in some embodiments, a switch having an IIP3 of +85 dBm can be utilized if there is no post-switch filtering.

In some embodiments, an antenna architecture having one or more features as described herein can be implemented in a device, a facility, and/or a system that utilizes beam tilting functionality. In some embodiments, such a device, facility and/or system can be configured to provide 5G functionality.

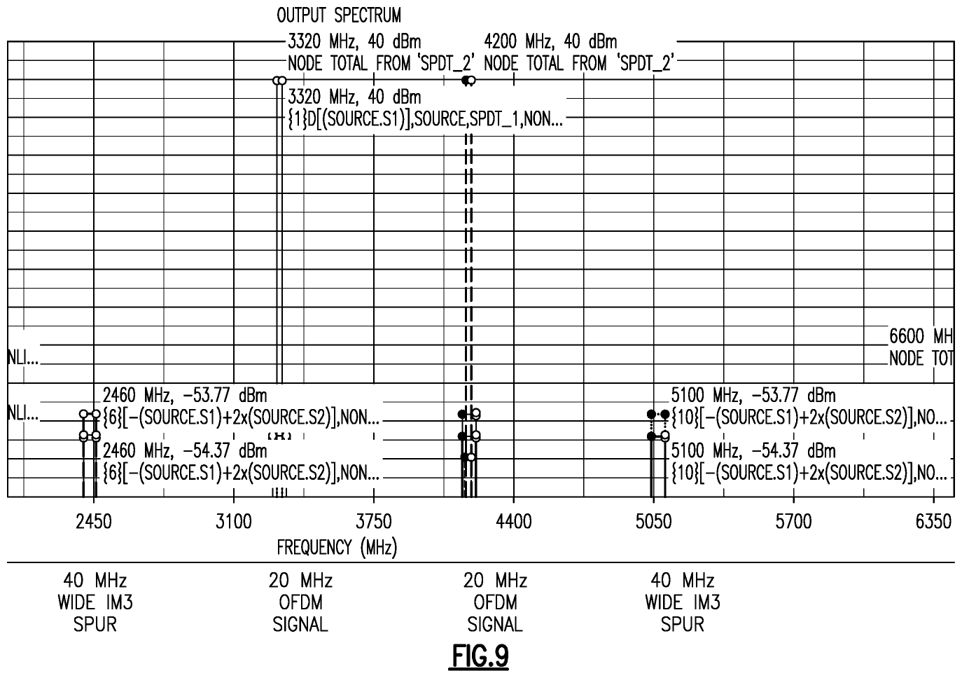

For example, FIG. 10 shows a block diagram of a wireless system 400 that includes an antenna architecture 100 having one or more features as described herein. Such an antenna architecture can be operatively with a transceiver 402 through either or both of a transmit circuit 410 (e.g., including a power amplifier) and a receive circuit 410 (e.g., including a low-noise amplifier). The transceiver 402 can be in communication with a baseband sub-system 404 that is configured to process digital and/or analog signals.

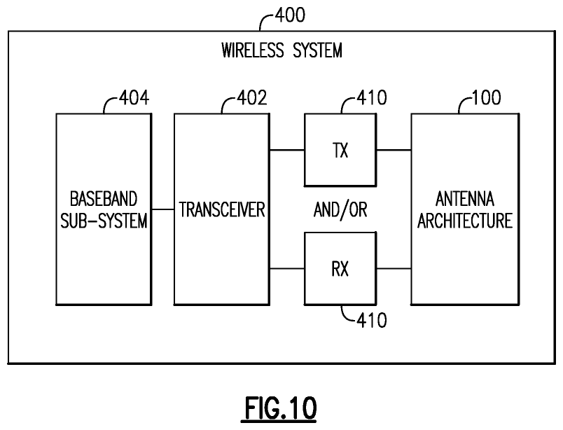

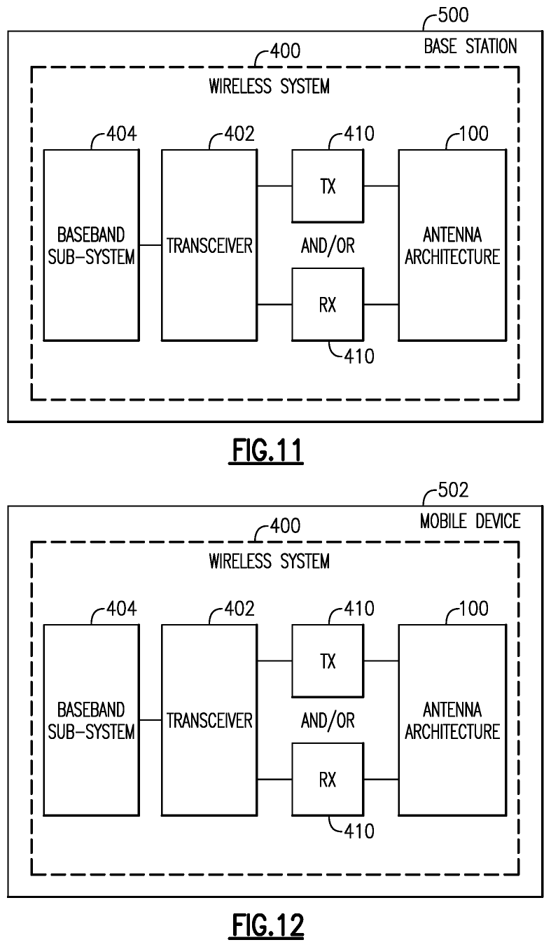

FIG. 11 shows that in some embodiments, substantially all of the wireless system 400 of FIG. 10 can be implemented within a base station 500 such as a cellular base station. FIG. 12 shows that in some embodiments, substantially all of the wireless system 400 of FIG. 10 can be implemented within a mobile device 502.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. An antenna architecture comprising:
a common node;
a plurality of signal paths each having first and second ends, the first end coupled to the common node, such that a common signal provided at the common node splits into respective signals in the signal paths;
a phase shifter block implemented along each of at least some of the signal paths, the phase shifter block including a phase shifting line configured to provide a phase shift for the signal passing through the respective signal path, such that the signals emerging from the signal paths are provided with incremental phase shifts; and
an antenna unit coupled to the second end of each signal path, such that the signals provided to the antenna units result in a transmitted signal being directed at a tilt angle with respect to the antenna units.

2. The architecture of claim 1 wherein the common node is configured to be coupled to a transceiver through a power amplifier.

3. The architecture of claim 1 wherein the antenna unit includes an antenna pair.

4. The architecture of claim 1 wherein each incremental phase shift has a value of Δφ.

5. The architecture of claim 4 wherein the plurality of signal paths includes N signal paths, the quantity N being an integer greater than 1.

6. The architecture of claim 5 wherein the quantity N is an even number.

7. The architecture of claim 6 wherein the signal paths include a first signal path providing a phase shift of zero for a first antenna unit, and a second signal path providing a phase shift of −Δφ with a respective phase shifter block for a second antenna unit on one side of the first antenna unit.

8. The architecture of claim 7 wherein the signal paths further include a third signal path providing a phase shift of +Δφ with a respective phase shifter block for a third antenna unit on the other side of the first antenna unit, and a fourth signal path providing a phase shift of −2Δφ with a respective phase shifter block for a fourth antenna unit next to the second antenna unit.

9. The architecture of claim 5 wherein the quantity N is an odd number.

10. The architecture of claim 9 wherein the signal paths include a first signal path providing a phase shift of zero for a first antenna unit, a second signal path providing a phase shift of −Δφ with a respective phase shifter block for a second antenna unit on one side of the first antenna unit, and a third signal path providing a phase shift of +Δφ with a respective phase shifter block for a third antenna unit on the other side of the first antenna unit.

11. The architecture of claim 10 wherein the signal paths further include a fourth signal path providing a phase shift of −2Δφ with a respective phase shifter block for a fourth antenna unit next to the second antenna unit, and a fifth signal path providing a phase shift of +2Δφ with a respective phase shifter block for a fifth antenna unit next to the third antenna unit.

12. The architecture of claim 5 wherein N-1 of the signal paths is/are each provided with a respective phase shifter block, and the remaining one signal path does not include a phase shifter block.

13. The architecture of claim 12 wherein the phase shifting line of each of the N-1 phase shifter blocks for supporting the tilt angle of the transmitted signal is one of M phase shifting lines corresponding to M tilt angles of the transmitted signal, the quantity M an integer greater than 1, such that the phase shifter block is configured to switchably introduce a selected phase shifting line for the phase shifter block to support a selected tilt angle of the transmitted signal.

14. The architecture of claim 13 wherein each phase shifter block includes a first SPMT switch with the single pole coupled to the common node and the M throws coupled to first ends of the M phase shifting lines, and a second SPMT switch with the M throws coupled to second ends of the M phase shifting lines and the single pole coupled to the respective antenna unit.

15. The architecture of claim 13 wherein the N-1 phase shifter blocks include a phase shifter block for providing a phase shift of +Δφ and another phase shifter block for providing a phase shift of −Δφ.

16. The architecture of claim 15 wherein each of the M switchable phase shifting lines of the phase shifter block is dimensioned to provide the phase shift of +Δφ in a positive direction from zero degree, and each of the M switchable phase shifting lines of the other phase shifter block is dimensioned to provide the phase shift of −Δφ in a negative direction from zero degree.

17. The architecture of claim 15 wherein each of the M switchable phase shifting lines of the phase shifter block is dimensioned to provide the phase shift of +Δφ in a positive direction from zero degree, and the other phase shifter block includes M switchable phase shifting lines that are dimensioned the same as the M switchable phase shifting lines of the phase shifter block, the other phase shifter block further including a static phase shifting line in line with the M switchable phase shifting lines, such that the other phase shifter block provides the phase shift of −Δφ.

18. The architecture of claim 1 wherein at least the phase shifting line is implemented on a substrate having a dielectric constant greater than 20, 30, or 40.

19. (canceled)

20. (canceled)

21. (canceled)

22. (canceled)

23. A method for operating a plurality of antenna units, the method comprising:
providing a common signal to a common node;
splitting the common signal into a plurality of signal paths each having first and second ends, the first end coupled to the common node, such that the common signal splits into respective signals in the signal paths;
providing a phase shift along each of at least some of the signal paths, the phase shift provided at least in part by a phase shifting line along the respective signal path, such that the signals emerging from the signal paths are provided with incremental phase shifts; and
transmitting a signal through an antenna unit coupled to the second end of each signal path, such that the transmitted signal from the antenna units is directed at a tilt angle with respect to the antenna units.

24. A wireless system comprising:
a transceiver; and
an antenna architecture operatively coupled to the transceiver, the antenna architecture including a common node and a plurality of signal paths each having first and second ends, the first end coupled to the common node, such that a common signal provided at the common node splits into respective signals in the signal paths, the antenna architecture further including a phase shifter block implemented along each of at least some of the signal paths, the phase shifter block including a phase shifting line configured to provide a phase shift for the signal passing through the respective signal path, such that the signals emerging from the signal paths are provided with incremental phase shifts, the antenna architecture further including an antenna unit coupled to the second end of each signal path, such that the signals provided to the antenna units result in a transmitted signal being directed at a tilt angle with respect to the antenna units.

25. (canceled)

26. (canceled)

27. (canceled)
